(19) United States
(12) Patent Application Publication
(10) Pub. No.: US 2019/0030813 A1
(43) Pub. Date: Jan. 31, 2019

(54) TRANSPORTING STRAY BUILD MATERIAL

(71) Applicant: HEWLETT-PACKARD DEVELOPMENT COMPANY, L.P., Houston, TX (US)

(72) Inventors: Randall Dean West, Vancouver, WA (US); Samuel A. Stodder, Carlsbad, CA (US)

(21) Appl. No.: 16/069,839

(22) PCT Filed: Apr. 22, 2016
(86) PCT No.: PCT/US2016/028874

§ 371 Date: Jul. 12, 2018

(51) Int. Cl. B29C 64/357; B22F 3/00; B29C 64/321; B33Y 30/00; B33Y 40/00

(52) U.S. Cl. CPC B29C 64/357; B22F 3/003; B22F 2003/1059; B33Y 30/00; B33Y 40/00; B29C 64/321

(57) ABSTRACT

In some examples, a build material delivery system for a printing system includes a moveable belt to transport a build material between locations in the printing system, where an outer surface of the belt is to carry the build material. A drive system is to move the belt, and the drive system includes a roller to engage an inner surface of the belt, the inner surface of the belt comprising transport structures defining cavities to transport stray build material that has seeped into an inner region containing the drive system from the outer surface of the belt.

### BACKGROUND

A three-dimensional (3D) printing system can be used to form 3D objects. A 3D printing system performs a 3D printing process, which is also referred to as an additive manufacturing (AM) process, in which successive layers of material(s) of a 3D object are formed under control of a computer based on the 3D model or other electronic representation of the object. The layers of the object are successively formed until the entire 3D object is formed.

### BRIEF DESCRIPTION OF THE DRAWINGS

Some implementations of the present disclosure are described with respect to the following figures.

FIG. 1 is a schematic side view of a build material delivery system according to some examples.

FIG. 2 is a schematic side view of a build material delivery system according to further examples.

FIGS. 3A-3C are schematic perspective views of portions of a printing system according to some examples.

FIG. 4 is a perspective view of a bottom portion of a printing system according to some examples.

FIG. 5 is a schematic front view of a portion of a printing system according to some examples.

FIG. 6 is a schematic side view of a portion of a printing system according to further examples.

FIG. 7 is a flow diagram of a process of providing a build material delivery system according to some examples.

### DETAILED DESCRIPTION

In a 3D printing system, a build material (or multiple different build materials) can be used to form a 3D object, by depositing the build material(s) as successive layers until the final 3D object is formed. A build material can include a powdered build material that is composed of particles in the form of fine powder or granules. The powdered build material can include metal particles, plastic particles, polymer particles, or particles of other materials. The powdered form of the build material makes the build material free flowing in some examples.

Build material(s) can be transported from a build material reservoir (or multiple build material reservoirs) of the printing system to a printing bed (or more simply “bed”) of the printing system, where layers of the build material(s) are formed on the bed. The printing bed can also be referred to as a build platform. A build material is delivered in metered amounts and at specified temperatures.

In some examples, a build material can be transported by a conveyor belt that is able to carry the build material from the reservoir to a target delivery location. A “conveyor belt,” or more simply a “belt,” can refer to a transport structure having a transport surface on which a build material can be provided for transport between different locations in a printing system; note that further structures can be formed on the transport surface, where such further structures can define cavities in which the build material can be received for transport. Such further structures are described further below.

The conveyor belt can be moved by a drive system that includes rollers. A roller can refer to a rotatable member that is able to engage an inner surface of the belt to cause movement of the belt as the roller rotates.

During operation of a printing system, particles of a powdered build material transported by a conveyor belt can seep through small cracks or openings (such as around the side edges of the conveyor belt) and enter a region containing the drive system. Such particles of the build material that enter the drive system can be referred to as stray build material. The stray build material can accumulate over time, and can interfere with proper operation of the drive system. For example, the stray build material can clog up parts of the drive system and may even cause damage to some parts.

To prevent stray build material from entering the drive system from the transport surface of the conveyor belt, a seal can be provided at the side edges of the conveyor belt. The seal can be provided by sealing structures arranged along the side edges of the conveyor belt. However, the sealing structures can wear out over time with use, and can thus be less effective. Also, maintaining and/or repairing such sealing structures can be expensive. Moreover, adding such sealing structures to a printing system can increase the complexity and cost of the printing system.

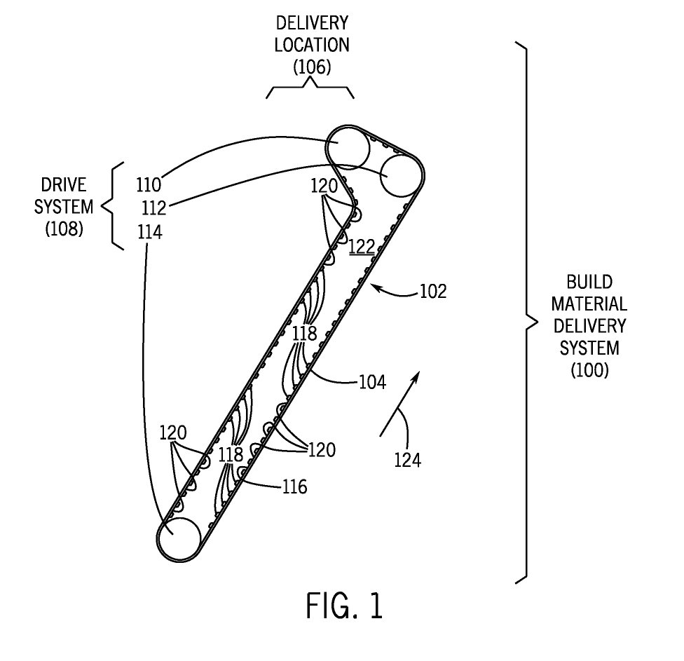

In accordance with some implementations of the present disclosure, as shown in FIG. 1, a build material delivery system 100 for a printing system includes a conveyor belt 102 to transport a build material (or build materials) between locations in the printing system, where an outer surface 104 of the belt 102 is to carry the build material(s) to a delivery location 106 for delivery to a delivery platform (not shown in FIG. 1). A drive system 108 moves the belt 102, where the drive system includes rollers 110, 112, and 114 to engage an inner surface 116 of the belt 102. Although three rollers are shown in FIG. 1, it is noted that in other examples, less than three or more than three rollers can be employed as part of the drive system to move the belt 106. At least one of the rollers 110, 112, and 114 can be driven (rotated) by a motor (not shown in FIG. 1) to cause movement of the belt 102.

The inner surface 116 of the belt 102 includes transport structures 118 defining cavities 120 to carry stray build material that has seeped into an inner region 122 of the belt 102, where the drive system 108 is located in the inner region 122. Each cavity 120 is able to receive a respective volume of stray build material.

The transport structures 118 are inward protrusions that project from the inner surface 116 of the belt 102. In some examples, the inward protrusions can rise from the inner surface 116 of the belt 102 in a direction that is generally perpendicular to the inner surface 116, or in a direction that is inclined at an angle (different from a right angle) with respect to the inner surface 116.

The transport structures 118 effectively provide a teeth profile. Although not shown in FIG. 1, the outer surface 104 of the belt 102 can similarly include transport structures and cavities that are similar to the transport structures 118 and cavities 120 provided on the inner surface 116 of the belt 102. The transport structures and cavities formed on the outer surface 104 of the belt 102 are to carry portions of build material from a build material reservoir to the delivery location 106, where the build material can be moved to a delivery platform and subsequently can be spread onto a printing bed to form a layer a 3D object.

Stray build material refers to build material that has seeped from the outer surface 104 of the belt 102 into the inner region 122. Within the inner region 122, the stray build material can fall downwardly, due to gravity, towards the roller 114. The stray build material can pass through the roller 114 (which has an interstitial design to provide gaps through which the stray build material can pass) to the inner surface 116 of the belt 102. Further details regarding the interstitial design of the roller 114 (and possibly other rollers) of the drive system 108, are discussed further below.

Portions of the stray build material are carried within the cavities 120 between the transport structures 118, upwardly generally along the direction of movement of the belt 102, as indicated by arrow 124.

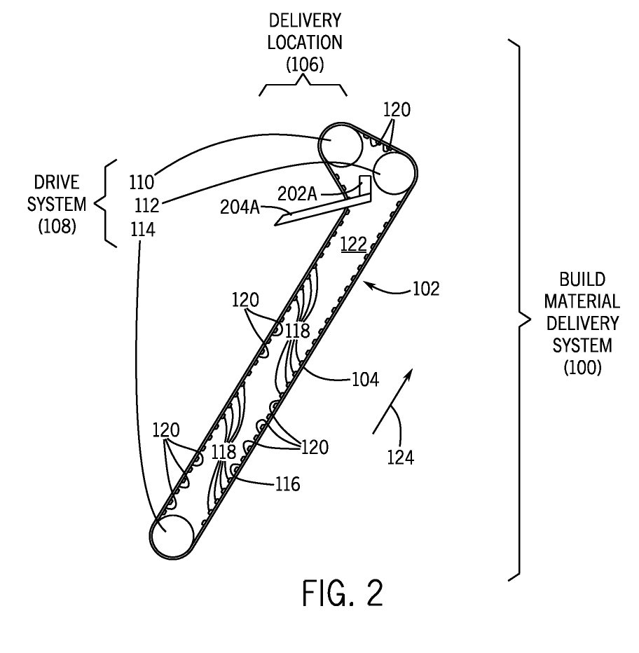

As shown in FIG. 2, after the stray build material has been carried by the cavities 120 to an upper portion (corresponding to an upper position) of the build material delivery system 100, the stray material can fall, due to gravity, from the cavities 120 into an inner transport chute 202A. The inner transport chute 202A is connected to an interconnecting transport chute 204A. The interconnecting transport chute 204A has a transport path that is communicatively connected to a transport path of the inner transport chute 202A. The interconnecting transport chute 204A defines a transport path that extends from the inner region 122 within the belt 102 to a region that is external of the belt 102.

The combination of the inner transport chute 202A and the interconnecting transport chute 204A provides a transport conduit along which the stray build material flows away from the inner surface 116 of the belt 102 to a build material reservoir that is outside the inner region 122 of the belt 102. Generally, a “transport chute” can refer to a structure that defines a path along which a material (e.g. a stray build material) can flow or otherwise be carried.

In other examples, just one transport chute or more than the two separate transport chutes 202A and 204B can be used to carry stray build material from the inner region 122 to outside of the inner region 122.

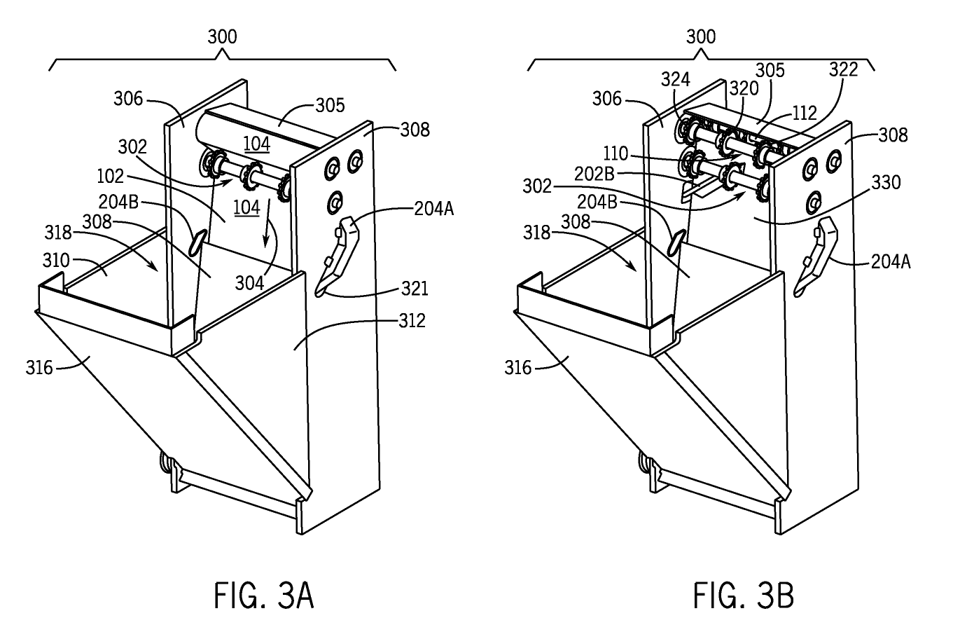

FIGS. 3A-3C depict portions of a printing system 300 according to further implementations. In FIG. 3A, the conveyor belt 102 is shown (more specifically, the outer surface 104 of the belt 102 is shown). In FIG. 3B, the conveyor belt 102 is omitted. FIG. 3A also shows a roller 302 to push the belt 102 inwardly in the return path of the belt 102 as the belt 102 circulates around the upper part of the printing system 300 and proceeds downwardly along direction 304 (hereinafter referred to as the return path 304 of the belt 102). The presence of the roller 302 defines a recessed contour in the portion of the belt 102 against which the roller 302 is engaged.

The ends of the roller 302 are rotatably mounted to side panels 306 and 308 of the printing system 300, where the side panels 306 and 308 are part of a housing of the printing system 300. The side panels 306 and 308 partially define the inner region 122 (FIG. 1). In addition, a reservoir panel 308 is provided between the side panels 306 and 308, and is adjacent a lower portion of the outer surface 104 of the belt 102. The reservoir panel 308 in conjunction with other housing panels 310, 312, and 316 define a build material reservoir 318 that stores build material that is to be carried by the belt 104 to the delivery location 106 (FIG. 1) of the printing system 300.

An outer housing 305 is also provided that is adjacent a portion of the outer surface 104 of the belt 102. The outer housing 305 is arranged to maintain a build material between the outer surface 104 of the belt 102 and the inner surface of the outer housing 305.

The interconnecting transport chutes 204A and 204B can be attached to the side panels 308 and 306, respectively.

In FIG. 3A, a portion of the interconnecting transport chute 204A is shown. The visible portion of the external transport chute 204A is attached to the outside of the side panel 308. A first end portion of the interconnecting transport chute 204A comes from inside the panel 308, and a second end portion of the interconnecting transport chute 204A extends through an opening 321 in the side panel 308 to allow for transport of stray build material to the build material reservoir 318.

The interconnecting transport chute 204A is provided on the right side of the print system 300 in the view of FIG. 3A. The left side of the print system 300 is provided with another interconnecting transport chute 204B, which provides the same functionality as the interconnecting transport chute 204A. In FIG. 3A, the end portion of the interconnecting transport chute 204B is visible, and shows the end portion of the external transport chute 204B extending inside the side panel 306 to allow for stray build material to be delivered into the build material reservoir 318.

FIG. 3B is a view of the printing system 300 with the belt 102 omitted. With the belt 102 omitted, the rollers 110 and 112 are visible, as is an inner transport chute 202B (which is similar to the inner transport chute 202A shown in FIG. 2 but is provided on a different side of the printing system 300 than the inner transport chute 202A). In addition, with the belt 102 omitted, an inner housing 330 is also visible in FIG. 3B. As further shown in FIG. 3C, the inner surface of the belt 102 (or more specifically, the transport structures 118 of the belt 102) are in contact with the inner housing 330 along the return path 304 (FIG. 3A) of the belt 102.

The inner transport chute 202B extends to the first end portion of the interconnecting transport chute 204B, to allow for communication of stray build material through the transport path of the inner transport chute 202B to the transport path of the interconnecting transport chute 204B.

In examples according to FIG. 3B, each of the rollers 110, 112, and 302 has an interstitial design, where each roller 110, 112, or 302 includes ring-shaped rolling structures that allow for gaps to be defined on either side of each of the ring-shaped rolling structures. For example, the roller 110 includes a ring-shaped rolling structure 320 and a ring-shaped rolling structure 322. Each ring-shaped rolling structure 320 or 322 includes a teeth profile with protruding gear teeth that can be used to engage the inner surface 116 of the belt 102. As further shown in FIG. 3B, gaps can be provided between the ring-shaped rolling structures 320 and 322, as well as between the ring-shaped rolling structure 320 and a first end portion 324 of the roller 110 that is coupled to the side panel 306. In addition, a gap can be provided between the ring-shaped rolling structure 322 and a second end portion of the roller 110 that is coupled to the side panel 308.

Each ring-shaped rolling structure 320 or 322 includes a gear profile (in the form of a toothed wheel), where protrusions of the gear profile of the ring-shaped rolling structure can engage the teeth profile of the inner surface 116 of the belt 102, such that the belt 102 can be moved by rotation of the rolling structure.

Although not entirely visible in FIG. 3B, the roller 112 can have a similar design as the roller 110. In addition, the roller 302 also has a similar design as the roller 110. In other examples, the rollers 110, 112, and 302 can have different designs. Also, each of the rollers 110, 112, and 302 can be configured without the interstitial design; in other words, the rolling structure with the gear profile would extend the full length of the respective roller.

Although not depicted in FIGS. 3A-3B, the roller 114 (FIG. 1) at the bottom part of the build material delivery system 100 can also have an interstitial design similar to that of the roller 110, 112, or 302.

FIG. 3C is a perspective side view of the printing system 300 with the side panel 308 of FIGS. 3A-3B removed. As can be seen in FIG. 3C, the inner transport chute 202A provides a transport path for the stray build material that extends from a location below the inner surface 116 of the upper portion of the belt 102 to the interconnecting transport chute 204A. The interconnecting transport chute 204A extends from the inner region 122 to the build material reservoir 318.

As further shown in FIG. 3C, a portion of the belt 102 along the upward path 124 of the belt 102 is sandwiched between the outer housing 305 and an inner housing 331 of the printing system 300. The inner region 122 inside the belt 102 is defined partially between the inner housings 330 and 331.

The inner transport chutes 202A and 202B can be attached to the inner housing 330 and/or to other structures in the printing system 300.

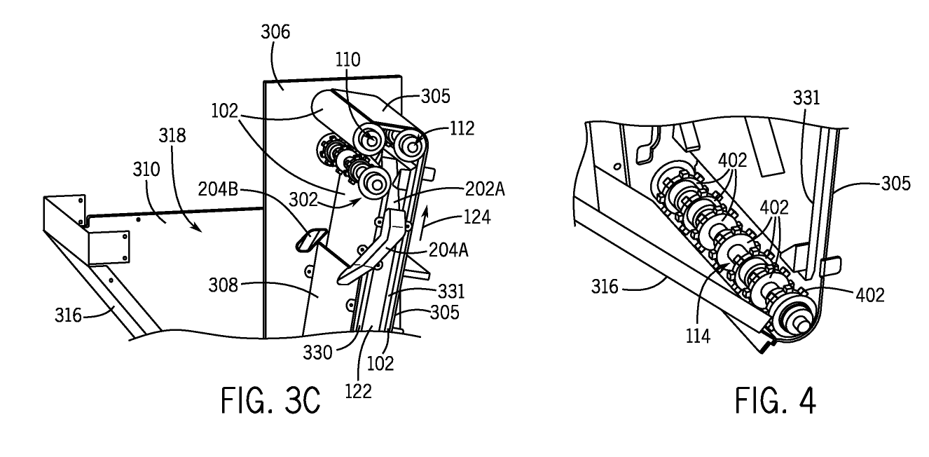

FIG. 4 shows the interstitial design of the roller 114 according to further implementations. The roller 114 in examples according to FIG. 4 includes ring-shaped rolling structures 402. Gaps are provided between successive pairs of the ring-shaped rolling structures 402, to allow stray build material that falls to the roller 114 to pass through the gaps of the roller 114 to corresponding cavities 120 on the inner surface 116 of the belt 102. The gaps between the successive pairs of the ring-shaped rolling structures 402 are large enough such that the free-flowing stray build material can flow through the gaps without flow restrictions that can cause clogging of the stray build material.

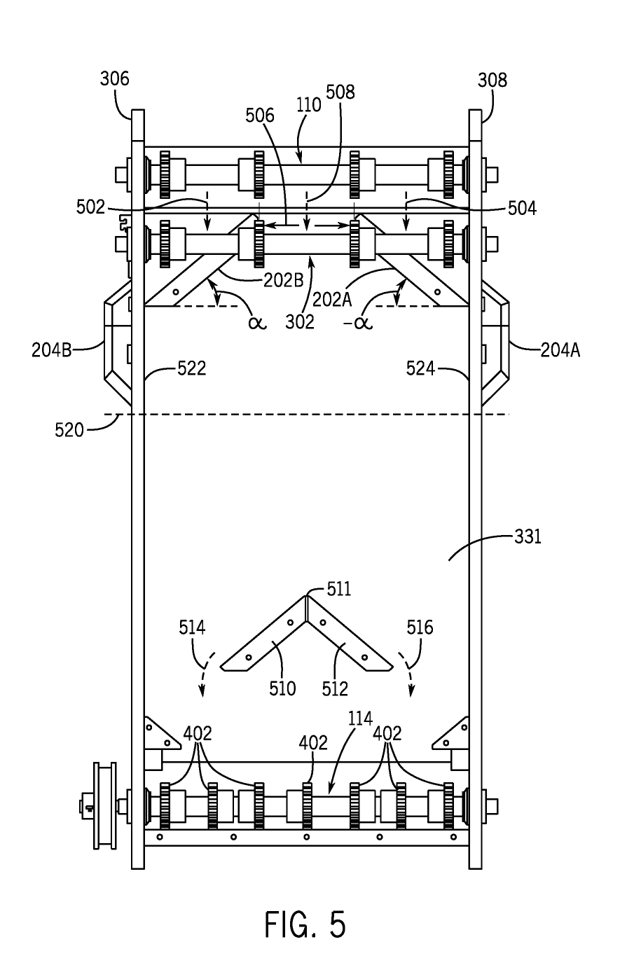

FIG. 5 is a front view of the printing system 300 with the front panel 316 of the stray material reservoir 318 and the inner housing 330 removed. The inner housing 331 is visible in FIG. 5. Stray powdered build material lifted up by the cavities 120 inside the belt 102 falls (along paths indicated generally by arrows 502 and 504) out of the cavities 120 once the cavities reach the top as the belt 102 circulates. Most of the stray build material is caught by the inner transport chutes 202A and 202B, where the caught stray build material is diverted by the inner transport chutes 202A, 202B and interconnecting transport chutes 204A, 204B to outside the inner region 122 inside the belt 102. A remainder portion of the stray build material falls (along paths indicated generally by arrow 508) through a gap 506 between the inner transport chutes 202A and 2026. This remainder portion of the stray build material falls onto lower diverting transport chutes 510 and 512, which are arranged in the inner region 122 inside the belt. The diverting transport chutes 510 and 512 can be attached to the inner housing 331.

In some examples, the diverting transport chutes 510 and 512 can form a general upside-down V profile, such that the diverting transport chutes 510 and 512 provide transport paths for stray build material that diverts away (outwardly) from an apex 511 of the upside-down V profile.

The stray build material that is diverted by the diverting transport chutes 510 and 512 fall generally along paths 514 and 516, respectively, towards the roller 114. The stray build material falling along paths 514 and 516 pass through the gaps between the ring-shaped rolling structures 402, and is caught by the cavities 120 formed inside the belt 102. The stray build material diverted by the diverting transport chutes 510 and 512 are passed to the left and right outer target portions of the belt 102, rather than to the middle portion of the belt 102. As a result, when the diverted stray build material is carried by the belt 102 to the upper portion of the build material delivery system 100, the diverted stray build material will fall towards the inner transport chutes 202A and 202B rather than towards the gap 506.

Since gravity is used to move the powdered build material through the inner transport chutes 202A and 202B, the inner transport chutes 202A and 202B are arranged at an incline. The inner transport chute 202A has a longitudinal axis (along its length) that is inclined at an angle α with respect to a horizontal axis. Similarly, the inner transport chute 202B has a longitudinal axis (along its length) that is inclined at an angle −α with respect to the horizontal axis. The angle α is greater than the critical incline angle below which the stray powdered build material will not slide due to friction between the stray powdered build material and the sliding surface of the inner transport chute.

In alternative examples, the inner transport chutes 202A and 202B can be arranged such that the angle α can be set small enough such that the inner transport chutes 202A and 202B can form a general upside-down V profile (similar to that formed by the diverting transport chutes 510 and 512), such that the inner transport chutes 202A and 202B provide transport paths for stray build material that diverts away (outwardly) from an apex (not shown) of the upside-down V profile. This alternative arrangement can eliminate the gap 506, such that the diverting transport chutes 510 and 512 would not have to be provided since there would not be stray build material falling through the eliminated gap 506.

The inner transport chutes 202A and 202B extend a certain vertical distance, which is dependent upon the horizontal distance along which each inner transport chute extends, and the respective angles α and −α of the inner transport chutes. In addition, the interconnecting transport chutes 204A and 204B extend a certain vertical distance back into the build material reservoir 318 (FIG. 3A). The delivery heights 522 and 524 at which the interconnecting transport chutes 204A and 204B deliver the stray build material back into the build material reservoir 318 is above a maximum height 520 that the build material in the build material reservoir 318 can reach. By setting the delivery heights 522 and 524 of the interconnecting transport chutes 204A and 204B above this maximum height 520, the build material inside the build material reservoir 318 will not block the outlets of the interconnecting transport chutes 204A and 204B.

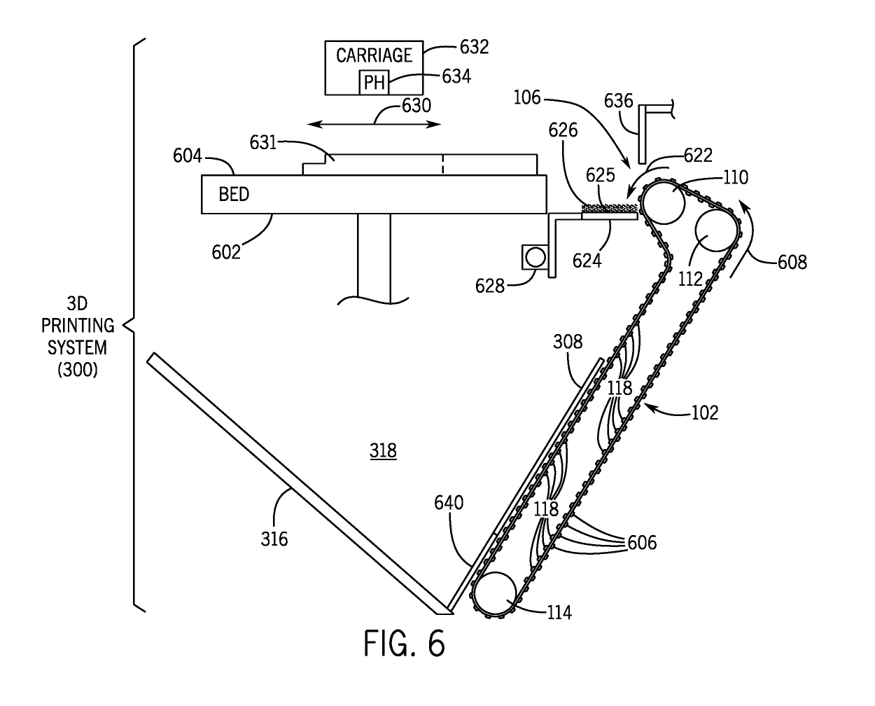

FIG. 6 shows a portion of a 3D printing system 300 according to some examples. The 3D printing system 300 includes a printing bed (or build platform) 602 that has a flat upper surface 604 on which a build material (or multiple build materials) can be provided in layers as part of a 3D printing operation. In examples according to FIG. 6, the build material reservoir 318 is located below the printing bed 602. With this arrangement, the powdered build material can be stored in the build material reservoir 318 (defined by panels 308 and 316 in the view of FIG. 6) below the printing bed 602, which enables a compact (lower height) architecture (compared to printing systems where the powdered material is stored above the printing bed and is gravity fed to the printing bed). In some cases, it may be desirable to arrange the 3D printing system 300 such that the printing bed 602 is at a convenient working height for a human operator. By using the conveyor structure including the conveyor belt 102 according to some examples, it is possible to store the powdered build material below this height, rather than above the height, which can achieve a 3D printing system with a lower overall height.

The printing system 300 further includes the moveable conveyor belt 102 that can be moved in a circulating manner, along circulating direction 608. A circulating belt refers to a belt that moves in a closed loop on a continual basis. In other examples, other types of moveable conveyor belts with other movement patterns can be used.

In examples according to FIG. 6, in addition to the transport structures 118 formed on the inner surface of the belt 102, the outer surface of the belt 102 is also formed with transport structures 606 that form a teeth profile similar to that provided by the transport structures 118 on the belt inner surface. The transport structures 606 on the belt outer surface define cavities in which build material is carried from the build material reservoir 318 (through an opening 640) towards the delivery location 106 due to circulation of the belt 102.

An outer housing (503 as shown in FIGS. 3A-3C) of the printing system 300 can be provided outside of the belt 102 such that the build material carried by the belt 102 can be trapped between the outer surface of the belt 102 and the inner surface of the outer housing as the build material is transported by the belt 106.

In some examples, the build material on the outer surface of the belt 106 (and more specifically, in the cavities defined by the transport structures 606) is transported to the delivery location 106 where the build material is deposited generally as indicated by arrow 622 (due to gravity and the motion of the belt 102) onto an upper surface 625 of a moveable delivery platform 624. The delivery platform 624 is moveable between a lowered position (the position shown in FIG. 6) and a raised position that is higher than the lowered position, where the top surface 625 of the delivery platform 624 can be level with or slightly higher than the upper surface 604 of the printing bed 602. In some examples, the delivery platform 624 is moveable along a vertical axis. In other examples, the delivery platform 124 is moveable along a diagonal axis that is slanted or angled with respect to the vertical axis.

As shown in FIG. 6, the delivery platform 624 is in its lowered position, to allow the build material on the belt 102 to be deposited onto the upper surface 625 of the delivery platform 624 as the belt 102 moves past the delivery platform 624. The deposited build material is referenced as 626 in FIG. 6. A metered amount of build material can be deposited onto the delivery platform 624. Metering an amount of build material onto the delivery platform 624 refers to delivering a target volume of build material onto the delivery platform 624, where the metering can be based on a specified distance traveled by the belt 102, or a time of operation of the belt 102. Thus, the belt 102 can be moved a specified distance to deliver an amount of build material associated with this specified distance onto the delivery platform 624.

After the metered amount of the build material 626 has been deposited onto the upper surface 625 of the delivery platform 624, the belt 102 can be stopped, and an actuator 628 can be activated to raise the delivery platform 624 to the raised position. At the raised position, the upper surface 625 of the delivery platform 624 on which the deposited build material 626 is provided is substantially at the same height as the upper surface 604 of the printing bed 602 (or substantially at the same height of the upper surface of a target object 631 that has been formed so far by the 3D printing operation on the printing bed 602). Being “substantially at the same height” can mean that the upper surface 625 of the delivery platform 624 and the upper surface 604 of the printing bed 602 (or the upper surface of the target object 631) are aligned so that the deposited build material 626 can be pushed onto the upper surface 604 of the printing bed 602 (or the upper surface of the target object 631) from the upper surface of the delivery platform 624.

The combination of the belt 102, rollers 110, 112, and 114, the delivery platform 624, and the actuator 628 (along with other components, such as the motor to drive the roller 110, 112, and/or 114) can be collectively considered to be a build material delivery system that is useable within the printing system 300. The build material delivery system is to transport a build material from a build material reservoir below the printing bed 602 to the delivery location 106. With this arrangement, the powdered build material can be stored below the printing bed 602, which enables a compact (lower height) architecture (compared to printing systems where the powdered material is stored above the printing bed and is gravity fed to the printing bed).

After the delivery platform 624 has been moved by the actuator 628 to the raised position, a spreader 636 (moveable along a spreading axis 630) can be used to spread the deposited build material 626 across the upper surface of the target object 631. The spreader 636 can be in the form of a blade or a roller, as examples.

As further shown in FIG. 6, the 3D printing system 300 includes a carriage 632 that carries a printhead 634 (or multiple printheads). The printhead 634 can be used to deposit a chemical agent (e.g. a liquid agent) onto portions of a layer of powdered build material that in combination with heating of the layer of powdered build material causes fusing of such portions as part of forming the target object 631. In further examples, a chemical agent delivered by the printhead 634 can be used to perform another operation with respect to portions of a layer of powdered build material.

In other examples, instead of or in addition to using the printhead 634 to deliver a chemical agent, the 3D printing system 300 can use laser sintering that uses a laser beam to sinter portions of powdered build material to bind such portions. In further examples, techniques or mechanisms according to some implementations can be applied to other types of 3D printing systems in which a powdered build material is to be delivered to a printing bed.

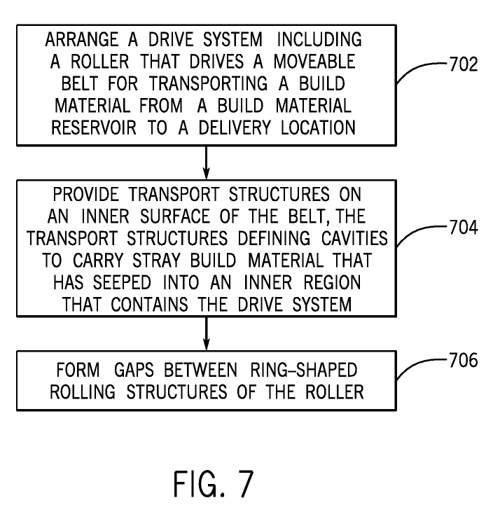

FIG. 7 is a flow diagram of a process of providing a build material delivery system according to some examples. The process includes arranging (at 702) a drive system including a roller that drives a moveable belt for transporting a build material from a build material reservoir to a delivery location. The process further includes providing (at 704) transport structures on an inner surface of the belt, the transport structures defining cavities to carry stray build material that has seeped into an inner region that contains the drive system.

The process further includes forming (at 706) gaps between ring-shaped rolling structures of the roller, the gaps to allow the stray build material to pass from the inner region to the cavities of the belt.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A build material delivery system for a printing system, comprising:
a moveable belt to transport a build material between locations in the printing system, wherein an outer surface of the belt is to carry the build material;
a drive system to move the belt, the drive system comprising a roller to engage an inner surface of the belt, the inner surface of the belt comprising transport structures defining cavities to transport stray build material that has seeped into an inner region containing the drive system from the outer surface of the belt.

2. The build material delivery system of claim 1, further comprising a first transport chute to receive a portion of the stray build material falling from the cavities of the belt.

3. The build material delivery system of claim 2, wherein the first transport chute extends inside the inner region and is to carry the portion of the stray build material to a second transport chute to carry the portion of the stray build material to a build material reservoir of the printing system.

4. The build material delivery system of claim 2, further comprising a diverting transport chute to divert another portion of the stray build material not received by the first transport chute along a path towards a target portion of the belt.

5. The build material delivery system of claim 1, wherein the roller includes plural ring-shaped rolling structures, wherein a gap is defined between each successive pair of the plural ring-shaped rolling structures.

6. The build material delivery system of claim 5, wherein the gaps are to allow the stray build material to flow past the roller and onto the inner surface of the belt.

7. The build material delivery system of claim 5, wherein at least a first ring-shaped rolling structure of the plural ring-shaped rolling structures comprises a gear profile to engage with a profile provided by the transport structures of the inner surface of the belt.

8. The build material delivery system of claim 1, wherein the outer surface of the belt comprises transport structures defining cavities to carry portions of the build material to a delivery location for delivering the build material to a printing bed.

9. The build material delivery system of claim 1, wherein the cavities are to carry the stray build material to an upper portion of the build material delivery system due to movement of the belt, and a portion of the stray build material is to fall from the cavities that have reached the upper portion of the build material delivery system.

10. A printing system comprising:
a moveable belt comprising an outer surface to transport build material to a delivery location in the printing system;
a drive system to move the belt, the drive system comprising a roller to engage an inner surface of the belt, the inner surface of the belt comprising transport structures defining cavities to transport stray build material that has seeped into an inner region containing the drive system from the outer surface of the belt; and
a transport conduit to receive a portion of the stray build material that falls from the cavities of the belt once the portion of the stray build material has been moved to an upper position.

11. The printing system of claim 10, wherein the transport conduit comprises a plurality of transport chutes, the plurality of transport chutes comprising a first transport chute in the inner region, and a second transport chute that has a transport path that is communicatively connected to a transport path of the first transport chute, the second transport chute to deliver the portion of the stray build material to a build material reservoir.

12. The printing system of claim 11, wherein the belt is to transport the build material from the build material reservoir to the delivery location.

13. The printing system of claim 11, further comprising a side panel that defines the inner region, the second transport chute having a portion that is outside of the side panel.

14. The printing system of claim 10, further comprising a moveable delivery platform to which the build material is delivered from the belt at the delivery location, the moveable delivery platform moveable between a lowered position and a raised position to allow spreading of the delivered build material from the delivery platform to a printing bed.

15. A method of providing a build material delivery system, comprising:
arranging a drive system comprising a roller that drives a moveable belt for transporting a build material from a build material reservoir to a delivery location;
providing transport structures on an inner surface of the belt, the transport structures defining cavities to carry stray build material that has seeped into an inner region that contains the drive system; and
forming gaps between ring-shaped rolling structures of the roller, the gaps to allow the stray build material to pass from the inner region to the cavities of the belt.
